(19) United States
(12) Patent Application Publication
(10) Pub. No.: US 2006/0244171 A1
(43) Pub. Date: Nov. 2, 2006

(54) In-Mold Decoration process

(76) Inventors: Chuan-Shien Yu, Taipei (TW); Dean-Kuo Liu, Taoyuan Hsien (TW); Lu-Chin Wu, Tanshui Town (TW)

Correspondence Address: LOWE HAUPTMAN BERNER, LLP, 1700 DIAGONAL ROAD, SUITE 300, ALEXANDRIA, VA, 22314, US

(21) Appl. No.: 11/118,416

(22) Filed: May 2, 2005

(51) Int. Cl. B29C 45/14

(52) U.S. Cl. 264/132; 264/250; 264/265; 264/161

(57) ABSTRACT

An In-Mold Decoration process has the following steps. A plastic film is provided. The plastic film is preformed into a desired shape by heat and pressure. A metal film is formed under the plastic film. A colored ink layer is coated under the metal film and is then baked. The appliqué is inserted into a mold cavity and compatible material is injection molded behind the appliqué. A finished IMD product with a metal-like appearance is presented.

### BACKGROUND

1. Field of Invention

The present invention relates to an In-Mold Decoration process. More particularly, the present invention relates to an In-Mold Decoration process integrating a metal film coating process.

2. Description of Related Art

A convention In-Mold Decoration (IMD) technology combines a film printing step, a preforming step and a mold injection step. When the above technologies are applied to different kinds of plastic film, various IMD products are produced, such as an outer housing for a unit of electronic equipment, or a car.

A transparent plastic film, formed on an exterior of an IMD product, can protect a graphic design thereunder from damage. Thus, this technology has gradually replaced a conventional process of directly printing graphics on a surface of an object.

If a metal-like appearance of an IMD product is desired, a metal film needs to be integrated into the IMD process. A vacuum sputtering or an evaporation deposition is generally used to deposit the metal film under the plastic film. After depositing the metal film and printing graphics, the plastic film is preformed in a desired shape.

After preforming, extra plastic materials are trimmed away. Plastic appliqué is inserted into a mold cavity and a compatible resin is injection molded therein. By using proper plastic materials and injection methods, an IMD product is then completed.

However, when a vacuum sputtering or an evaporation deposition is integrated into IMD process, an IMD end product has foggy and hair-like defects that destroy the metal-like appearance. Therefore, IMD production yield drops after integrating a metal film coating process.

### SUMMARY

It is therefore an objective of the present invention to provide an In-Mold Decoration (IMD) process to enhance a metal-like appearance of an IMD product.

In accordance with the foregoing and other objectives of the present invention, an In-Mold Decoration process has following steps. A plastic film is provided. The plastic film is preformed in a desired shape by heat and pressure. A metal film is formed under the plastic film. A colored ink layer is coated under the metal film and is then baked. The appliqué is inserted into a mold cavity and a compatible material is injection molded behind the appliqué. A finished IMD product with a metal-like appearance is presented.

According to preferred embodiments, the plastic film is made from a polycarbonate, acrylonitrile butadiene styrene, polyethylene terephthalate, acrylic, or nylon material, and its thickness is from 0.03 mm to 0.8 mm. Additionally, the preforming step is conducted by a pressure pressing, a heat pressing, a vacuum pressing process, or any combination thereof. The metal film material can be gold, silver, copper, aluminum, nickel, chromium, or any combination thereof. The metal film is formed by a vacuum sputtering or an evaporation deposition process. The colored ink layer is formed by spraying or pad printing, and the colored ink can be UV curing ink or thermal curing ink.

Thus, this enhanced IMD process is used to manufacture a product which has a metal-like appearance. By preforming a plastic film first, and coating a metal film and a colored ink layer after preforming step, the foggy and hair-like defects, resulting from a high-temperature preforming step, in the metal-like appearance can be reduced.

It is to be understood that both the foregoing general description and the following detailed description are examples, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 is a flowchart of an In-Mold Decoration process according to one preferred embodiment of this invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

In order to overcome the foggy and hair-like defects in IMD (In-Mold Decoration) products, the present invention provides an enhanced IMD process. By preforming a plastic film first, and coating a metal film and a colored ink layer after the preforming step, thus the foggy and hair-like defects can be reduced.

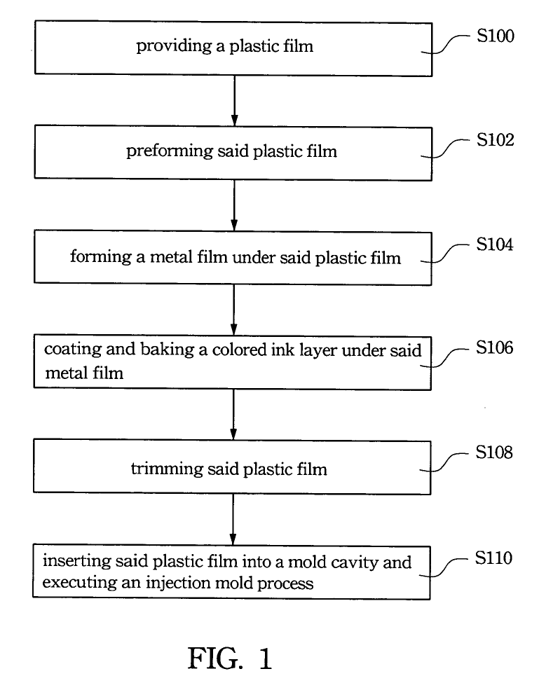

FIG. 1 is a flowchart of an In-Mold Decoration process. Step 100 is described with reference to FIG. 1. A plastic film is provided. The plastic film can be made from polycarbonate, acrylonitrile butadiene styrene, polyethylene terephthalate, acrylic, or nylon material. A thickness of the plastic film is from 0.03 mm to 0.8 mm.

Step 102 is described with reference to FIG. 1. The plastic film is preformed into a desired shape. According to a particular IMD product's geometry patterns or designs, Step 102 can be conducted by a pressure pressing, a heat pressing, or a vacuum pressing process.

Step 104 is described with reference to FIG. 1. A metal film is formed under the plastic film by a vacuum sputtering or an evaporation deposition to obtain a metal-like appearance. The metal film material can be gold, silver, copper, aluminum, nickel, chromium, or any combination thereof. By controlling film thickness, a prefect metal-like appearance can be obtained, such as total reflection or transparent character.

Step 106 is described with reference to FIG. 1. A colored ink layer is coated under the metal film by spraying or pad printing, and is then baked. The colored ink can be UV curing ink or thermal curing ink.

Step 108 is described with reference to FIG. 1. A trimming process is used to remove extra plastic material thus obtain desired final shape.

Step 110 is described with reference to FIG. 1. The plastic film after Step 108 is manually or robotically inserted into a mold cavity and executing an injecting process. During Step 110, a compatible resin is injection molded in under the colored ink layer.

According to the preferred embodiment, this enhanced IMD process is used to manufacture a product which has a metal-like appearance. By preforming a plastic film first, and coating a metal film and a colored ink layer after preforming step, the foggy and hair-like defects, resulting from a high-temperature of preforming step, in the metal-like appearance can be reduced.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An In-Mold Decoration process, comprising:
providing a plastic film;
preforming said plastic film;
forming a metal film under said plastic film;
coating a colored ink layer under said metal film and then baking said colored ink layer;
trimming said plastic film; and
inserting said plastic film into a mold cavity and executing an injection mold process.

2. The In-Mold Decoration process of claim 1, wherein said plastic film is made from a polycarbonate, acrylonitrile butadiene styrene, polyethylene terephthalate, acrylic, or nylon material.

3. The In-Mold Decoration process of claim 2, wherein a thickness of said plastic film is from about 0.03 mm to 0.8 mm.

4. The In-Mold Decoration process of claim 1, wherein said plastic film is preformed by a pressure pressing, a heat pressing, a vacuum pressing process, or any combination thereof.

5. The In-Mold Decoration process of claim 1, wherein said metal film material includes gold, silver, copper, aluminum, nickel, chromium, or any combination thereof.

6. The In-Mold Decoration process of claim 1, wherein said metal film is formed by a vacuum sputtering or an evaporation deposition process.

7. The In-Mold Decoration process of claim 1, wherein said colored ink layer is formed by spraying or pad printing.

8. The In-Mold Decoration process of claim 1, wherein said colored ink layer includes UV curing ink or thermal curing ink.
